(19) United States
(12) Patent Application Publication
(10) Pub. No.: US 2008/0242772 A1
(43) Pub. Date: Oct. 2, 2008

(54) Low electric conductivity high heat radiation polymeric composition and molded body

(75) Inventors: Yoshiki NAKAMURA, Aichi-ken (JP); Hideyuki FUJIWARA, Aichi-ken (JP); Hideyuki IMAI, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO. LTD, Nishikasugai-gun (JP)

(21) Appl. No.: 12/076,872

(22) Filed: Mar. 25, 2008

(30) Foreign Application Priority Data
Mar. 27, 2007 (JP) 2007-080490
Mar. 5, 2008 (JP) 2008-055563

(51) Int. Cl. C08L 95/00

(52) U.S. Cl. 524/70; 524/59; 524/71

(57) ABSTRACT

The present invention provides a low electric conductivity, high heat radiation polymeric composition which includes a polymeric material, from 10 to 35% by volume of a carbon fiber, and from 1 to 20% by volume of a ceramics.

### TECHNICAL FIELD

The present invention relates to a polymeric composition and a molded body having low electric conductivity and high heat radiation.

### BACKGROUND OF THE INVENTION

In consideration of environmental issues such as CO₂ reduction, advances are being made in reducing the fuel consumption of automobiles, and in recent years, hybrid vehicles have gained much attention. The spread of fuel cell vehicles and so on is also foreseen in the future. With respect to components related to batteries and motors, many products require low electric conductivity and high heat radiation, and various materials and shapes have been studied with a view to securing both of these characteristics.

However, it is difficult to secure both of these characteristics in a single material for practical use. The reason for this is that high thermal conductivity (which means thermal conductivity is high) is a prerequisite of high heat radiation, but almost all materials in practical use that possess high thermal conductivity also possess high electric conductivity. This will now be described more specifically.

(1) Metals possess both high thermal conductivity and high heat radiation, but also possess high electric conductivity, and therefore without modification, low electric conductivity (preferably electric insulation) cannot be secured. Accordingly, an insulating plate made of resin or the like must be provided separately, leading to problems regarding the low heat radiation of the insulating plate and the weight of the product, which increases in proportion to the weight of the insulating plate. Moreover, the specific gravity of the metal itself is high.
(2) Polymeric materials (resin, rubber) possess low electric conductivity (essentially electric insulation), but also possess low thermal conductivity, and therefore without modification, high heat radiation cannot be secured. Accordingly, the shape of the product must be manipulated (by creating air-transmitting passages) to secure high heat radiation, leading to an increase in the size of the product and a corresponding increase in the required disposal space.
(3) To solve these problems, the following composite materials have been studied.

Japanese Patent Application Publication No. JP-A-2002-88249 describes a composition formed by compounding a polymeric material with a graphitized hydrocarbon containing a boron compound.

Japanese Patent Application Publication No. JP-A-2002-3717 describes a composition formed by compounding silicone rubber with a graphitized carbon fiber and an electrical insulating thermally conductive filler.

Japanese Patent Application Publication No. JP-A-H9-321191 describes a composition formed by compounding a polymeric material with thermally conductive filler particles, the surface of which has been covered with a ceramics-based material.

Japanese Patent Application Publication No. JP-A-H7-145270 describes a composition formed by compounding a polymer such as rubber with an organic compound having a hydroxyl group and a metal oxide or the like.

Japanese Patent Application Publication No. JP-A-H7-111300 describes a composition formed by compounding silicone rubber with boron nitride.

Japanese Patent Application Publication No. JP-A-H7-33983 describes a composition formed by compounding silicone rubber with boron nitride, the surface of which has been covered with amino-modified silicone oil.

Japanese Patent Application Publication No. JP-A-2004-10880 describes a composition formed by compounding liquid silicone or the like with aluminum nitride powder and metal powder.

### SUMMARY OF THE INVENTION

JP-A-2002-88249, JP-A-2002-3717, JP-A-H9-321191, JP-A-H7-145270, JP-A-H7-111300, JP-A-H7-33983, and JP-A-2004-10880 all describe composite materials in which an attempt is made to secure both low electric conductivity and high heat radiation by filling a filler constituted by a ceramics or the like for achieving high heat radiation into a polymeric material (base material) for achieving low electric conductivity. However, the following problems arise in these composite materials.

(a) High heat radiation cannot be secured unless a considerably large amount of filler is filled (unless the filler is filled at a high density).
(b) A large amount of filler is charged, and therefore the shape of the product is restricted (limited to a sheet form).
(c) The cover may break during mixing so as to expose the conductive part of the filler, and therefore reliability is lacking.

It is an object of the present invention to solve the problems described above by providing a polymeric composition and a molded body capable of securing both low electric conductivity and high heat radiation.

[A] A low electric conductivity, high heat radiation polymeric composition of the present invention comprises a polymeric material, from 10 to 35% by volume of a carbon fiber, and from 1 to 20% by volume of a ceramics.

Aspects of each element of the present invention will be illustrated below using examples.

### [1] Polymeric Material

There are no particular limitations on the polymeric material, but resin, rubber, and a thermoplastic elastomer may be mentioned as examples, and PE (polyethylene), PP (polypropylene), PPS (polyphenylene sulfide), epoxy resin, and silicone rubber are preferably used.

1. Resin: an olefin-based resin such as PP or PE, a styrene-based resin such as PS (polystyrene), a vinyl resin such as PVC (polyvinyl chloride), PPS, LCP (liquid crystal polymer), PBT (polybutylene terephthalate), PET (polyethylene terephthalate), PA (polyamide) such as PA6 (polyamide 6), PTFE (polytetrafluoroethylene), an engineering plastic resin such as POM (polyacetal), or a thermosetting resin such as epoxy resin, phenol resin, or acrylic resin may be mentioned as examples.
2. Rubber: EPDM (ethylene propylene diene copolymer), CR (chloroprene rubber), NBR (butadiene-acrylonitrile rubber), silicone rubber, and the like may be mentioned as examples.
3. Thermoplastic elastomer: olefin-based, styrene-based, vinyl chloride-based, polyester-based, polyurethane-based, polyamide-based, and fluorine-based thermoplastic elastomers may be mentioned as examples.

There are no particular limitations on the polymeric material, but a material having a thermal conductivity of less than 1.0 W/m·K is preferable, and a material having a thermal conductivity of from 0.1 to 0.5 W/m·K is more preferable. More specifically, the materials shown in Table 1 below may be cited as examples. Further, Table 2 shows the thermal conductivity of the carbon fiber and the ceramics.

TABLE 1

| | | | |
|---|---|---|---|
| | Thermal | | Thermal |
| | conductivity | | conductivity |
| Material | (W/m · K) | Material | (W/m · K) |

| | | | | | |
|---|---|---|---|---|---|
| PE | 0.22 | *1 | PVC | 0.16 | *1 |
| PP | 0.14 | *2 | PET | 0.25 | *2 |
| PPS | 0.37 | *2 | PA6 | 0.25 | *1 |
| PBT | 0.23 | *2 | PTFE | 0.44 | *2 |
| CR | 0.25 | *1 | Epoxy resin | 0.4 | *2 |
| Silicone | 0.2 | *1 | Phenol resin | 0.33 | *2 |
| PS | 0.12 | *1 | | | |

*1: Technical Information Institute Publication “Technique for providing heat radiation material for electronic device/component with high thermal conductivity and measuring/evaluating thermal conductivity” p133
*2: Nikkan Kogyo Shimbun Publication “Material database organic material” p53

TABLE 2

| | | | |
|---|---|---|---|
| | Thermal | | Thermal |
| | conductivity | | conductivity |
| Material | (W/m · K) | Material | (W/m · K) |

| | | | | | |
|---|---|---|---|---|---|
| Pitch-based | 540 | *3 | Magnesia | 60 | *6 |
| carbon fiber | | | | | |
| PAN-based | 10 | *4 | Aluminum nitride | 170 | *6 |
| carbon fiber | | | | | |
| Boron nitride | 210 | *6 | Silicon nitride | 29 | *7 |
| Alumina | 36 | *6 | Silicon carbide | 56 | *7 |
| Zirconia | 2.1 | *5 | Boron carbide | 36 | *7 |

*3: Mitsubishi Chemical Resources Technical Document; Grade “K223HG” value
*4: Toray Technical Document; Grade “MLD30” value
*5: Internet
*6: Technical Information Institute Publication “Technique for providing heat radiation material for electronic device/component with high thermal conductivity and measuring/evaluating thermal conductivity” p133
*7: Technical Information Institute Publication “Technique for providing heat radiation material for electronic device/component with high thermal conductivity and measuring/evaluating thermal conductivity” p99

As regards the relationship between the thermal conductivity of a compound formed by filling (compounding) resin or the like with a ceramics and so on and the thermal conductivity and filling factor of the ceramics and so on, the Bruggeman formula shown below in Formula 1 exists. The thermal conductivity (shown in Table 1) of the resin or the like is smaller than the thermal conductivity (shown in Table 2) of the ceramics and carbon fiber, and therefore the effect of modifying the resin or the like on the thermal conductivity (variation in the thermal conductivity) of a compound formed by filling resin or the like with a ceramics and so on is small.

$$1 - φ = \frac{λ e - λ d}{λ c - λ d} \cdot {[ \frac{λ c}{λ e} ]}^{\frac{1}{3}} \qquad [ Formula 1 ]$$

φ: volume filling factor of ceramics and so on
λe: thermal conductivity of compound formed by filling resin or the like with ceramics and so on
λd: thermal conductivity of ceramics and so on
λc: thermal conductivity of resin or the like

### [2] Carbon Fiber

There are no particular limitations on the carbon fiber, but PAN-based carbon fiber and Pitch-based carbon fiber may be mentioned as examples, and Pitch-based carbon fiber is preferably used.

### [2-1] PAN-Based Carbon Fiber

Typically, PAN-based carbon fiber uses PAN (polyacrylonitrile) fiber as a raw material, and is manufactured by subjecting the PAN fiber to calcination at from 100° C. to 1500° C. in an inert gas followed by carbonization at from 2000° C. to 3000° C.

In PAN-based carbon fiber, the graphite crystals constituting the carbon fiber are small and disposed randomly, and therefore electricity and heat pass through the fiber easily in various directions. Furthermore, PAN-based carbon fiber contains a large number of crystal defects, and therefore the thermal conductivity is lower than that of pitch-based carbon fiber.

### [2-2] Pitch-Based Carbon Fiber

Typically, pitch-based carbon fiber uses petroleum tar as a raw material, and is manufactured by compounding the tar with various compounding agents such as a thickening agent, forming strings at from 250 to 400° C., carbonizing the resulting substance at from 1000 to 1500° C. in an inert gas, and then baking the resulting substance at from 2500 to 3000° C.

The graphite crystals in pitch-based carbon fiber are larger than those of PAN-based carbon fiber, arranged favorably in the fiber-length direction, and have fewer defects. Hence, electricity and heat pass through pitch-based carbon fiber easily in the fiber-length direction, and as a result, the thermal conductivity is far higher than that of PAN-based carbon fiber. Note that the thermal conductivity of the pitch-based carbon fiber increases greatly depending on the orientation, to be described below, and the reason for this is that when the fiber-length direction is aligned, the thermal conduction direction is also aligned.

### [3] Ceramics

There are no particular limitations on the ceramics, but metal oxides, metal nitrides and metal carbides may be mentioned as examples. Preferred examples thereof include boron nitride, alumina, and aluminum nitride. There are also no particular limitations on the form of the ceramics, but particle form, fiber form and scale form may be mentioned as examples. There are also no particular limitations on the dimensions, but the average particle diameter may be between 5 and 100 μm, for example.

### [3-1] Oxide

There are no particular limitations on the metal oxide, but alumina (Al₂O₃), zirconia (ZrO₂) and magnesia (MgO) may be mentioned as examples.

### [3-2] Nitride

There are no particular limitations on the metal nitride, but aluminumnitride (AlN), boronnitride (BN) andsiliconnitride (Si₃N₄) may be mentioned as examples.

### [3-3] Carbide

There are no particular limitations on the metal carbide, but silicon carbide (SiC) and boron carbide (B₄C) may be mentioned as examples.

### [4] Compound Amounts

### [4-1] Carbon Fiber Compound Amount

The amount of carbon fiber compounded with the polymeric material is from 10 to 35% by volume, and preferably from 15 to 30% by volume, and more preferably from 15 to 25% by volume. When the compound amount is too small, it tends to be impossible to secure a sufficient heat radiation property, and when the compound amount is too large, the low electric conductivity tends to be impaired, and workability tends to lower.

### [4-2] Ceramics Compound Amount

The amount of ceramics compounded with the polymeric material is from 1 to 20% by volume, and preferably from 5 to 15% by volume.

### [5] Orientation of Carbon Fiber

The carbon fiber compounded with the polymeric material may be used after being oriented by a magnetic field or the like. With this orientation, the thermal conductivity can be raised even when the compounding amount of the carbon fiber remains the same, or when the same thermal conductivity is sufficient, the compounding amount of the carbon fiber can be decreased. Orientation indicates a state in which carbon fiber is arranged regularly and in a specific direction within a polymeric material serving as a base material.

### [5-1] Confirmation and Evaluation of Orientation

The orientation can be confirmed using the following two methods and evaluated using Method 1 in particular, for example.

### 1. Azimuth Intensity Distribution Measurement of Crystal Lattice of Carbon Fiber Using X-Ray Diffraction Analysis

In carbon fiber, for example, graphite crystals are arranged regularly in a fiber-length direction, and by measuring the azimuth intensity distribution of the graphite crystal (0. 0. 2) surface through X-ray diffraction analysis (as in FIG. 5, to be described below, for example), the orientation direction of the carbon fiber can be learned. When the carbon fiber is oriented, a peak occurs in the azimuth intensity distribution. When the carbon fiber is particularly well oriented, the full width at half maximum (FWMH) is measured to define the degree of orientation as described below. When the degree of orientation is 0.7 or more, the orientation can be perceived visually, and the actions and effects of the orientation can be evaluated with clarity. A degree of orientation from 0.9 to 1 may be considered particularly favorable.

Degree of orientation=(180°−full width at half maximum)/180° <Formula 2>

2. Visual Confirmation Through Observation with Microscope Etc.

A molded body is cut along a surface on which the orientation is to be confirmed, and the direction of the carbon fiber is observed using a scanning electron microscope or the like. Note, however, that it is difficult to evaluate the degree of orientation quantitatively from this observation.

### [5-2] Orientation Direction

There are no particular limitations on the direction in which the carbon fiber in the polymeric material is oriented, but when the molded body includes a plate-form portion, for example, the carbon fiber may be oriented in either direction along the surface of the plate-form portion or in the thickness direction of the plate-form portion.

### [5-3] Orientation Method

There are no particular limitations on the method of orienting the carbon fiber, but the following magnetic field method and processing method may be cited as examples.

### 1. Method Using Magnetic Field

In this method, a molded body or a molded body serving as a material of the molded body is molded using the low electric conductivity, high heat radiation polymeric composition described above, and the carbon fiber in the polymeric material of the molded body is oriented using a magnetic field when the polymeric material is in a fluid state. The carbon fiber is oriented in the direction of the magnetic field (the direction of the line of magnetic force). Following orientation, the polymeric material is cooled or the like and hardened. There are no particular limitations on the intensity of the magnetic field, but a strong magnetic field of at least 1 T (tesla) is preferable. According to this method, various orientation directions including the orientation direction described above as an example can be realized simply by aligning the orientation direction with the direction of the magnetic field.

Here, there are no particular limitations on the fluid state of the polymeric material, but examples thereof include a molten state, a state prior to cross-linking, and a state prior to polymerization or the like.

### 2. Processing Method

In this method, a molded body or a molded body serving as a material of the molded body is molded using the low electric conductivity, high heat radiation polymeric composition described above, and the carbon fiber in the polymeric material of the molded body is oriented by deforming at least a part of the molded body in an elongated manner through processing performed when the polymeric material is in a fluid state. Thus, the carbon fiber is oriented in the elongation direction. Following orientation, the polymeric material is cooled or the like and hardened.

Note that in the methods described above, a molded body serving as a material of the molded body denotes a precursory molded body in a case where a plurality of molding stages is performed, for example a sheet member in a case where a molded body is molded into a three-dimensional shape by subjecting sheet members to vacuum molding or the like.

[B] A low electric conductivity, high heat radiation molded body of the present invention is molded using the low electric conductivity, high heat radiation polymeric composition described above.

There are no particular limitations on the specific products formed by the molded body, but the following products may be mentioned as examples.

(a) An insulating plate 12 or a battery case 13, for insulating battery elements in a battery pack 11 of an electrically driven vehicle such as a hybrid vehicle or a fuel cell vehicle, as shown in FIG. 2, or a bus bar module, or the like.

(b) A motor coil insulator/sealing material or the like for the motor of an electrically driven vehicle or the like.

(c) An inverter case for an electrically driven vehicle, a household appliance, or the like.

(d) A radiation sheet, a casing, or the like for a household appliance, personal computer, or the like.

The developmental background and actions of the present invention are as follows.

A carbon fiber has high thermal conductivity (and therefore high heat radiation), and has a reinforcing property in relation to polymeric material, and is therefore suitable for the present invention. However, a carbon fiber also has high electric conductivity, and therefore an object of the present invention was to suppress the electric conductivity of the composition formed by compounding the carbon fiber.

As a result of various investigations, it was found that by combining carbon fiber with various insulating ceramics and compounding the result with a polymeric material, a novel composition exhibiting both low electric conductivity and high heat radiation was obtained.

According to the polymeric composition and molded body of the present invention, both low electric conductivity and high heat radiation can be secured.

### BRIEF DESCRIPTION OF THE DRAWINGS

FIG. 1 is a schematic view illustrating a low electric conductivity, high heat radiation polymeric composition of the example product of the present invention;

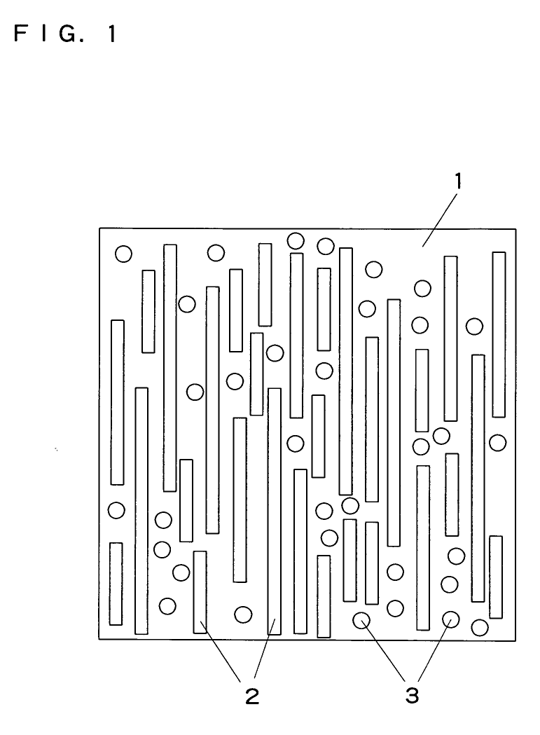

FIG. 2 is a perspective view showing an example of a molded body molded using the polymeric composition of the present invention.

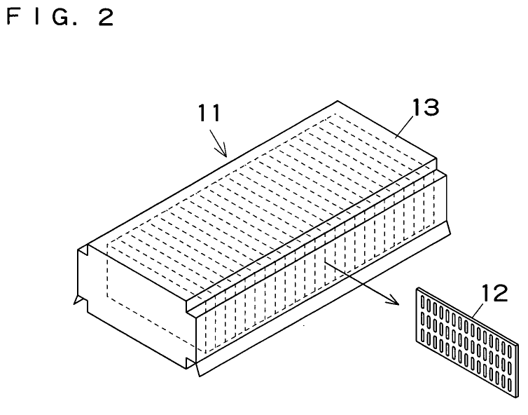

FIG. 3 is a view illustrating a device and a method for orienting carbon fibers using a magnetic field;

FIG. 4 is a view also illustrating the method for orienting carbon fibers using the magnetic field;

FIG. 5 is a graph showing the measurement results of the azimuth intensity distribution using an X-ray diffraction analysis;

FIG. 6 is a microphotograph of an example of a molded body in which carbon fibers were not oriented; and

FIG. 7 is a microphotograph of an example of a molded body in which carbon fibers were oriented.

### DETAILED DESCRIPTION OF THE INVENTION

The present invention is a low electric conductivity, high heat radiation polymeric composition which comprises a polymeric material compounded with from 15 to 30% by volume of a carbon fiber and from 5 to 15% by volume of a ceramics.

The present invention is also a molded body having low electric conductivity and high heat radiation using this low electric conductivity, high heat radiation polymeric composition.

### EXAMPLES

The following Table 3 shows the composition and physical properties of first through fifteenth examples and first through five comparative examples, which were formed using a polyethylene (PE) resin (manufactured by Sumitomo Chemical Co., Ltd., product name “Sumikasen G807”) as the base polymeric material 1. In the first through fifteenth examples, predetermined amounts of the carbon fiber 2 and ceramics 3 were compounded with the polyethylene resin, and in the first through five comparative examples, predetermined amounts of carbon fiber and so on were compounded with the polyethylene resin.

TABLE 3

| | | Comparative | Comparative | Comparative | Comparative | Comparative |
|---|---|---|---|---|---|---|
| Composition/Evaluation item | | Example 1 | Example 2 | Example 3 | Example 4 | Example 5 |
| Composition | Polyethylene resin | 100 | 75 | 60 | 75 | 60 |
| (% by volume) | Carbon fiber | | 25 | 40 | | |
| | Boron nitride | | | | 25 | 40 |
| | Alumina | | | | | |
| | Aluminum nitride | | | | | |
| Total amounts of | | 0 | 25 | 40 | 25 | 40 |
| carbon fiber and ceramics | | | | | | |
| Thermal conductivity (W/m · K) | | 0.3 | 1.2 | 2.3 | 0.8 | 1.2 |
| Volume specific resistance | | 1.0 × 10¹³ | 5.5 × 10 | 3.1 | 1.0 × 10¹³ | 1.0 × 10¹³ |
| (Ω · cm) | | or more | | | or more | or more |
| Composition/Evaluation item | | Example 1 | Example 2 | Example 3 | Example 4 | Example 5 |
| Composition | Polyethylene resin | 80 | 75 | 70 | 65 | 70 |
| (% by volume) | Carbon fiber | 15 | 20 | 20 | 20 | 25 |
| | Boron nitride | 5 | 5 | 10 | 15 | 5 |
| | Alumina | | | | | |
| | Aluminum nitride | | | | | |
| Total amounts of | | 20 | 25 | 30 | 35 | 30 |
| carbon fiber and ceramics | | | | | | |
| Thermal conductivity (W/m · K) | | 0.8 | 0.9 | 1.2 | 1.2 | 1 |
| Volume specific resistance | | 10 × 10¹⁴ | 3 × 10⁸ | 8 × 10⁶ | 2 × 10⁷ | 1.0 × 10⁶ |
| (Ω · cm) | | | | | | |
| Composition/Evaluation item | | Example 6 | Example 7 | Example 8 | Example 9 | Example 10 |
| Composition | Polyethylene resin | 65 | 60 | 65 | 60 | 55 |
| (% by volume) | Carbon fiber | 25 | 25 | 30 | 30 | 30 |
| | Boron nitride | 10 | 15 | 5 | 10 | 15 |
| | Alumina | | | | | |
| | Aluminum nitride | | | | | |
| Total amounts of | | 35 | 40 | 35 | 40 | 45 |
| carbon fiber and ceramics | | | | | | |
| Thermal conductivity (W/m · K) | | 2.5 | 1.6 | 1.3 | 2.3 | 3.6 |
| Volume specific resistance | | 3 × 10⁵ | 2 × 10⁵ | 3 × 10⁵ | 10 × 10⁴ | 4 × 10⁴ |
| (Ω · cm) | | | | | | |
| Composition/Evaluation item | | Example 11 | Example 12 | Example 13 | Example 14 | Example 15 |
| Composition | Polyethylene resin | 55 | 65 | 60 | 65 | 80 |
| (% by volume) | Carbon fiber | 35 | 25 | 25 | 30 | 15 |
| | Boron nitride | 10 | | | | |
| | Alumina | | 10 | 15 | 5 | |
| | Aluminum nitride | | | | | 5 |

| | | | | | |
|---|---|---|---|---|---|
| Total amounts of | 45 | 35 | 40 | 35 | 20 |
| carbon fiber and ceramics | | | | | |
| Thermal conductivity (W/m · K) | 4.2 | 2.3 | 1.1 | 1.5 | 1.1 |
| Volume specific resistance | 4.5 × 10² | 2 × 10⁴ | 7 × 10⁴ | 8 × 10⁴ | 8 × 10⁹ |
| (Ω · cm) | | | | | |

In the first through eleventh examples, carbon fiber and boron nitride were compounded. In the twelfth through fourteenth examples, carbon fiber and alumina were compounded. In the fifteenth example, carbon fiber and aluminum nitride were compounded.

Meanwhile, in the first comparative example, the polyethylene resin was used alone. In the second and third comparative examples, only carbon fiber was compounded. In the fourth and fifth comparative examples, only boron nitride was compounded. Table 4 below shows the composition and physical properties of sixteenth through forty-third examples and sixth through eighth comparative examples using polypropylene (PP) resin (manufactured by Japan Polypropylene Corporation, product name “Novatec PP”), polyphenylene sulfide (PPS) resin (manufactured by Toray Industries Inc., product name “Torelina A900”), silicone rubber (manufactured by Shin-Etsu Chemical Co., Ltd., product name “KE106”) or bisphenol A-type epoxy resin (manufactured by Refine-Tec, product name “Epo-mount”) instead of polyethylene (PE) resin as the base polymeric material 1.

TABLE 4

| | | Comparative | | | | |
|---|---|---|---|---|---|---|
| Composition/Evaluation item | | Example 6 | Example 16 | Example 17 | Example 18 | Example 19 |
| Composition | Polypropylene | 100 | 80 | 75 | 55 | 55 |
| (% by volume) | resin | | | | | |
| | Carbon fiber | | 15 | 20 | 30 | 35 |
| | Boron nitride | | 5 | 5 | 15 | 10 |
| | Alumina | | | | | |
| | Aluminum nitride | | | | | |
| Compound amount of | | 0 | 20 | 25 | 45 | 45 |
| Carbon fiber and Celamics | | | | | | |
| Thermal conductivity (W/m · K) | | 0.3 | 1.0 | 1.1 | 1.3 | 2.2 |
| Volume specific resistance | | 1.0 × 10¹³ | 3 × 10⁷ | 1 × 10⁹ | 4 × 10⁷ | 2 × 10³ |
| (Ω · cm) | | or more | | | | |
| Composition/Evaluation item | | Example 20 | Example 21 | Example 22 | Example 23 | Example 24 |
| Composition | Polypropylene | 80 | 75 | 55 | 55 | 75 |
| (% by volume) | resin | | | | | |
| | Carbon fiber | 15 | 20 | 30 | 35 | 20 |
| | Boron nitride | | | | | |
| | Alumina | 5 | 5 | 15 | 10 | |
| | Aluminum nitride | | | | | 5 |
| Compound amount of | | 20 | 25 | 45 | 45 | 25 |
| Carbon fiber and Celamics | | | | | | |
| Thermal conductivity (W/m · K) | | 1.1 | 1.1 | 1.5 | 1.6 | 1.3 |
| Volume specific resistance | | 1 × 10⁸ | 2 × 10³ | 7 × 10⁵ | 1 × 10⁶ | 1 × 10⁶ |
| (Ω · cm) | | | | | | |
| | | Comparative | | | | |
| Composition/Evaluation item | | Example 7 | Example 25 | Example 26 | Example 27 | Example 28 |
| Composition | PPS resin | 100 | 80 | 75 | 55 | 55 |
| (% by volume) | Carbon fiber | 15 | 20 | 30 | 35 | |
| | Boron nitride | | 5 | 5 | 15 | 10 |
| | Alumina | | | | | |
| | Aluminum nitride | | | | | |
| Compound amount of | | 0 | 20 | 25 | 45 | 45 |
| Carbon fiber and Celamics | | | | | | |
| Thermal conductivity (W/m · K) | | 0.4 | 1.0 | 1.1 | 1.2 | 2.0 |
| Volume specific resistance | | 1.0 × 10¹³ | 3 × 10⁸ | 2 × 10⁸ | 2 × 10⁶ | 2 × 10⁴ |
| (Ω · cm) | | or more | | | | |
| Composition/Evaluation item | | Example 29 | Example 30 | Example 31 | Example 32 | Example 33 |
| Composition | PPS resin | 80 | 75 | 55 | 55 | 75 |
| (% by volume) | Carbon fiber | 15 | 20 | 30 | 35 | 20 |
| | Boron nitride | | | | | |
| | Alumina | 5 | 5 | 15 | 10 | |
| | Aluminum nitride | | | | | 5 |

| | | | | | |
|---|---|---|---|---|---|
| Compound amount of | 20 | 25 | 45 | 45 | 25 |
| Carbon fiber and Celamics | | | | | |
| Thermal conductivity (W/m · K) | 1.1 | 1.2 | 1.4 | 1.8 | 1.3 |
| Volume specific resistance | 1 × 10⁸ | 4 × 10⁴ | 5 × 10⁵ | 1 × 10³ | 1 × 10⁷ |
| (Ω · cm) | | | | | |

| | | Comparative | | | | |
|---|---|---|---|---|---|---|
| Composition/Evaluation item | | Example 8 | Example 34 | Example 35 | Example 36 | Example 37 |
| Composition | Silicone rubber | 100 | 80 | 75 | 55 | 55 |
| (% by volume) | Bis phenol-A epoxy resin | | | | | |
| | Carbon fiber | | 15 | 20 | 30 | 35 |
| | Boron nitride | | 5 | 5 | 15 | 10 |
| | Alumina | | | | | |
| | Aluminum nitride | | | | | |

| | | | | | |
|---|---|---|---|---|---|
| Compound amount of | 0 | 20 | 25 | 45 | 45 |
| Carbon fiber and Celamics | | | | | |
| Thermal conductivity (W/m · K) | 0.3 | 0.9 | 1.1 | 1.7 | 2 |
| Volume specific resistance (Ω · cm) | 1.0 × 10¹³ | 2 × 10¹¹ | 2 × 10⁹ | 2 × 10⁵ | 7 × 10⁴ |
| | or more | | | | |

| | | | | | | Example | Example |
|---|---|---|---|---|---|---|---|
| Composition/Evaluation item | | Example 38 | Example 39 | Example 40 | Example 41 | 42 | 43 |
| Composition | Silicone rubber | 80 | 75 | 55 | 55 | 75 | |
| (% by volume) | Bis phenol-A epoxy resin | | | | | | 80 |
| | Carbon fiber | 15 | 20 | 30 | 35 | 20 | 15 |
| | Boron nitride | | | | | | |
| | Alumina | 5 | 5 | 15 | 10 | | 5 |
| | Aluminum nitride | | | | | 5 | |

| | | | | | | |
|---|---|---|---|---|---|---|
| Compound amount of | 20 | 25 | 45 | 45 | 25 | 20 |
| Carbon fiber and Celamics | | | | | | |
| Thermal conductivity (W/m · K) | 1.1 | 1.3 | 1.6 | 2.2 | 1.2 | 0.9 |
| Volume specific resistance (Ω · cm) | 1 × 10¹⁰ | 2 × 10⁸ | 5 × 10⁴ | 1 × 10⁴ | 1 × 10⁷ | 1 × 10⁸ |

The base polymeric material used in each of the samples was polypropylene resin in the sixteenth through twenty-fourth examples and the sixth comparative example, PPS resin in the twenty-fifth through thirty-third examples and the seventh comparative example, silicone rubber in the thirty-fourth through forty-second examples and the eighth comparative example, and bisphenol A-type epoxy resin in the forty-third example.

Further, the sixteenth through nineteenth, twenty-fifth through twenty-eighth, and thirty-fourth through thirty-seventh examples employed a compound of carbon fiber and boron nitride, the twentieth through twenty-third, twenty-ninth through thirty-second, thirty-eighth through forty-first, and forty-third examples employed a compound of carbon fiber and alumina, and the twenty-fourth, thirty-third, and forty-second examples employed a compound of carbon fiber and aluminum nitride.

Note that the carbon fiber used in this test is a pitch-based carbon fiber manufactured by Mitsubishi Chemical Functional Products, Inc. under the product name of “Dialead K223HGM” (average particle diameter: Φ10×50 μm), the boron nitride (BN) used in the test is manufactured by GE Specialty Materials under the product name of “PT110” (average particle diameter 50 μm), the alumina (Al₂O₃) used in the test is manufactured by Denki Kagaku Kogyo under the product name of “DAW10” (average particle diameter 10 μm), and the aluminum nitride (AlN) used in the test is manufactured by Toyo Aluminum under the product name of “FAN-f80” (average particle diameter 80 μm).

### [Molding and Physical Properties Test]

The compounded materials of each example and comparative example were mixed by a Segment mixer (model number “KF70V”) of a Laboplastomill manufactured by Toyo Seiki Seisaku-Sho Ltd. under the following conditions: temperature 210° C. (polyethylene resin), 200° C. (polypropylene resin), 320° C. (PPS resin), room temperature (silicone rubber and bisphenol A-type epoxy resin); rotation speed 100 rpm; time 10 minutes; filling rate 70%. Each mixed material was press-molded by a hand press device at a pressure of 20 MPa under the following conditions:

polyethylene resin: at 210° C. for 5 minutes,

polypropylene resin: at 200° C. for 5 minutes,

PPS resin: at 320° C. for 5 minutes,

silicone rubber: at 150° C. for 30 minutes,

bisphenol A-type epoxy resin: at room temperature for 24 hours, whereby a test piece measuring 25 mm×25 mm×(thickness) 2 mm was created.

The physical properties of each test piece were measured using the following method.

### (1) Thermal Conductivity Measurement

A measuring device with the product name of “Xe Flash Analyzer LFA447 Nanoflash”, manufactured by NETZSCH, was used, and measurement was performed at 25° C. (room temperature). The direction of the thermal conductivity corresponds to the thickness direction of the test piece.

### (2) Volume Specific Resistance Measurement

When the volume specific resistance was equal to or lower than 10⁶ Ω·cm, a measuring device with the product name of “Loresta GP”, manufactured by Dia Instruments Co., Ltd. was used, and measurement was performed using a four-terminal method. Both the separation direction of the electric current application terminals (the electric current direction) and the separation direction of the potential taps (the potential difference direction) correspond to the thickness direction of the test piece. When the volume specific resistance was higher than 10⁶ Ω·cm, a measuring device with the product name of “Hiresta UP”, manufactured by Dia Instruments Co., Ltd. was used, and measurement was performed using a double ring method (conforming to JISK6911).

### [Evaluation of Physical Properties]

All of the example products secure both low electric conductivity (volume specific resistance is equal to or more than 1×10² Ω·cm) and high heat radiation (thermal conductivity is equal to or more than 0.5 W/m·K). On the other hand, the first, and sixth though eighth comparative examples secure low electric conductivity but exhibits poor heat radiation. The second and third comparative examples secure high heat radiation but exhibit extremely poor low electric conductivity. The fourth and fifth comparative examples secure both low electric conductivity and high heat radiation, but are lacking in mechanical strength and are therefore not suitable for practical application.

Note that when evaluating the heat radiation and electric conductivity of the various compound materials, the fact that the required levels of high heat radiation and low electric conductivity differ according to the specific product type of the low electric conductivity, high heat radiation molded body to be molded from the compound materials must be taken into account.

### [Preliminary Test for Orienting Carbon Fiber]

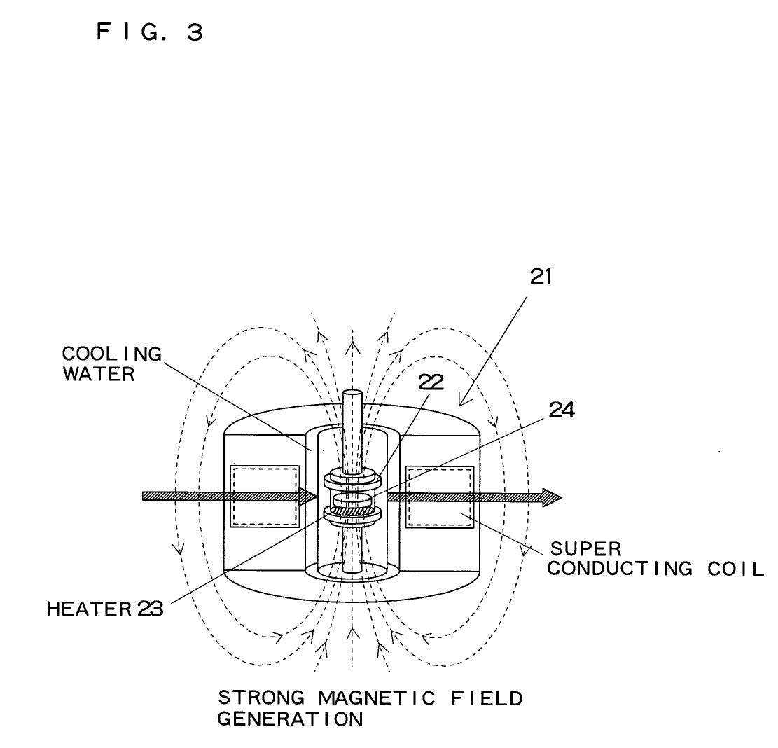

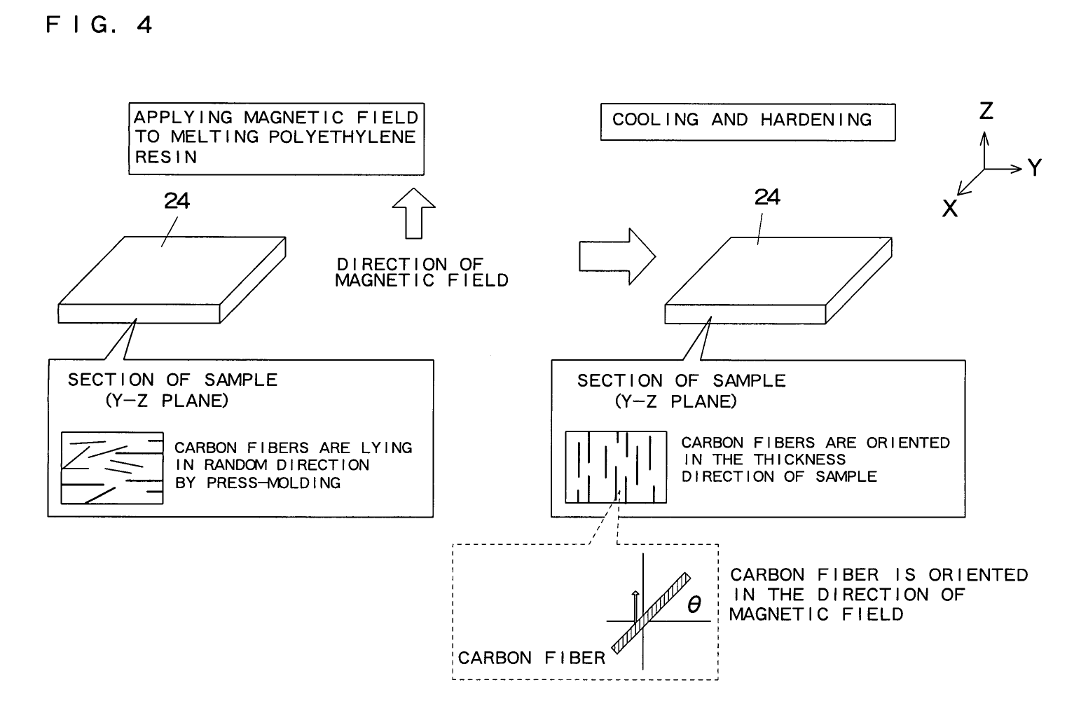

First, a preliminary test was performed to confirm that the carbon fiber could be oriented using a magnetic field. Five compositions, formed by respectively compounding 15% by volume, 25% by volume, 30% by volume and 35% by volume of pitch-based carbon fiber with a polyethylene resin and compounding 15% by volume of pitch-based carbon fiber with 5% by volume of alumina having an average particle diameter of 10 μm, were mixed under similar conditions to those described above and molded into a 25 mm×25 mm×2 mm test piece, whereupon a magnetic field was applied to the compound examples containing 15% by volume, 25% by volume and 35% by volume of carbon fiber and the example containing carbon fiber and alumina (a magnetic field was not applied to the compound example containing 30% by volume of carbon fiber, and a test in which a magnetic field was not applied to the compound example containing 25% by volume of carbon fiber was also performed). More specifically, orientation was performed using the following devices and procedures, as shown in FIGS. 3 and 4.

(1) A cooling type superconducting magnet device (HF10-100VHT), manufactured by Sumitomo Heavy Industries, Ltd., was used as a magnetic field generating unit.
(2) An electric heater 23 was disposed in the lower portion of a space 22 (bore) positioned in a central magnetic field portion of this device 21, and test pieces 24 described above were set on the electric heater 23 one by one such that the test piece thickness direction corresponded to the magnetic field direction (the direction of the magnetic force line).
(3) The test piece 24 was heated in the space by the electric heater 23 to a temperature region (during implementation, 220° C.) for melting polyethylene resin, and the polyethylene resin serving as the base material of the test piece was melted. At this time, the test piece was held so as to maintain the dimensions described above.
(4) The device was activated while maintaining the heating and temperature described above to apply a magnetic field (during implementation, 8 T (tesla)) to the test piece, and the test piece 24 was left within the magnetic field for one hour.
(5) Heating was then halted, and the test piece 24 was left for 0.5 hours to cool naturally so that the polyethylene resin base material of the test piece hardened.
(6) The test piece 24 was extracted from the space 22 in the device 21 and the orientation of the carbon fiber was confirmed.

The orientation of the carbon fiber was confirmed using the following two methods.

### 1. Azimuth Intensity Distribution Measurement of Crystal Lattice of Carbon Fiber Using X-Ray Diffraction Analysis

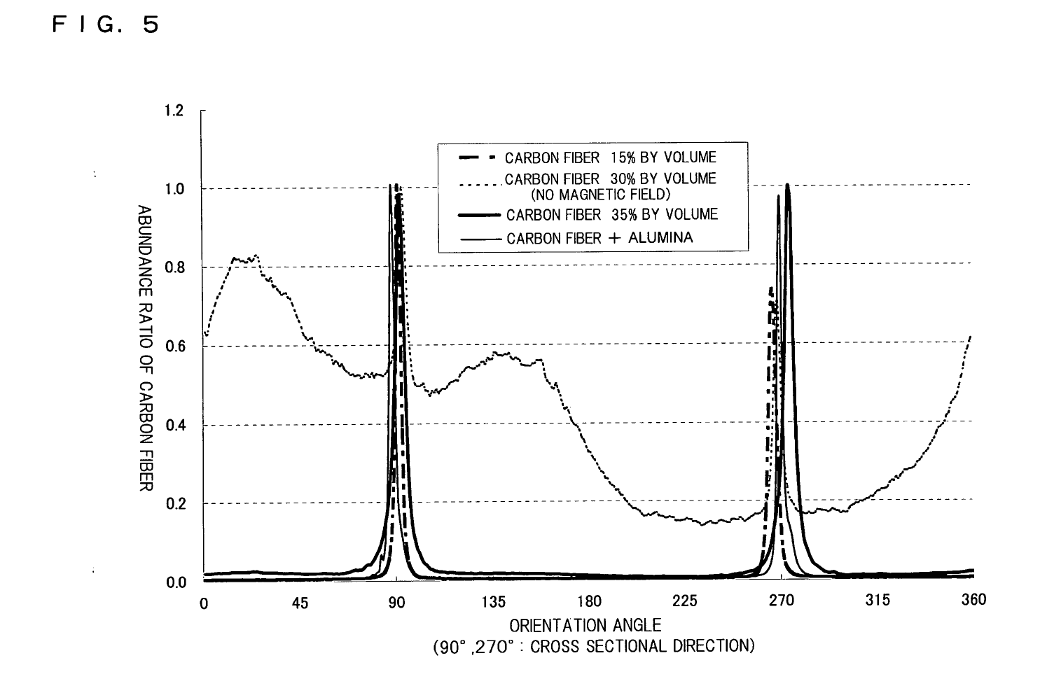

The azimuth intensity distribution on the surface of the graphite crystals (0. 0. 2) of the carbon fiber was measured in the manner described above, i.e. through X-ray diffraction analysis using an X-ray diffraction analysis device, in relation to the compound example containing 30% by volume of carbon fiber to which the magnetic field was not applied, the compound example containing 15% by volume of carbon fiber to which the magnetic field was applied, the compound example containing 35% by volume of carbon fiber to which the magnetic field was applied, and the example containing carbon fiber and alumina to which the magnetic field was applied. The measurement results are shown in FIG. 5. In the compound examples containing 15% by volume and 35% by volume of carbon fiber, and the example containing carbon fiber and alumina, to which the magnetic field was applied, respectively, the carbon fiber was oriented favorably in the thickness direction of the test piece 24, and a peak occurred in the azimuth intensity distribution. Having measured the full width at half maximum and determined the degree of orientation using Formula 2 described above, the compound example containing 15% by volume of carbon fiber and compound example containing 35% by volume of carbon fiber were found to have degrees of orientation of 0.98 and 0.97, respectively.

### 2. Visual Confirmation of Sample Using Microscope Observation

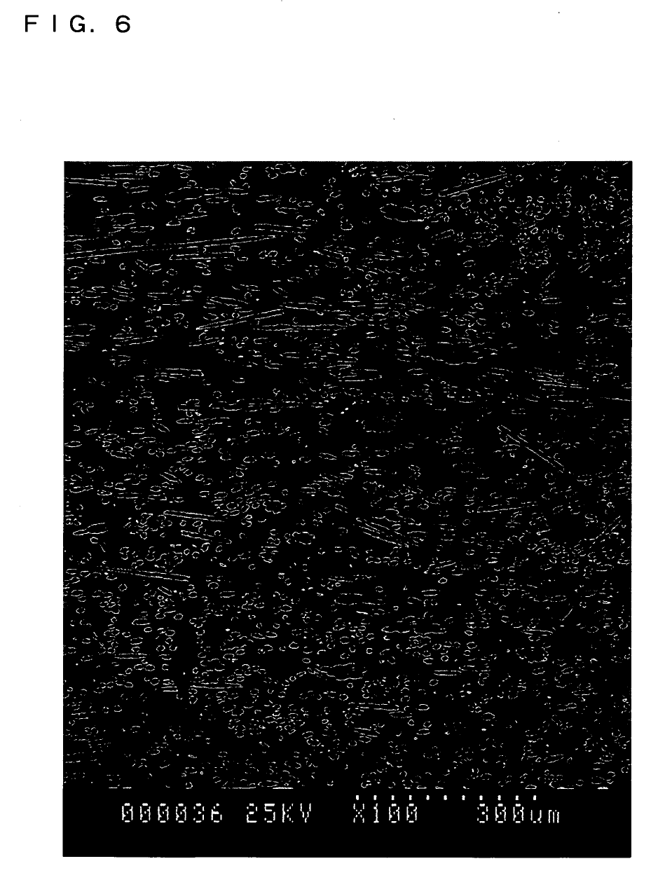

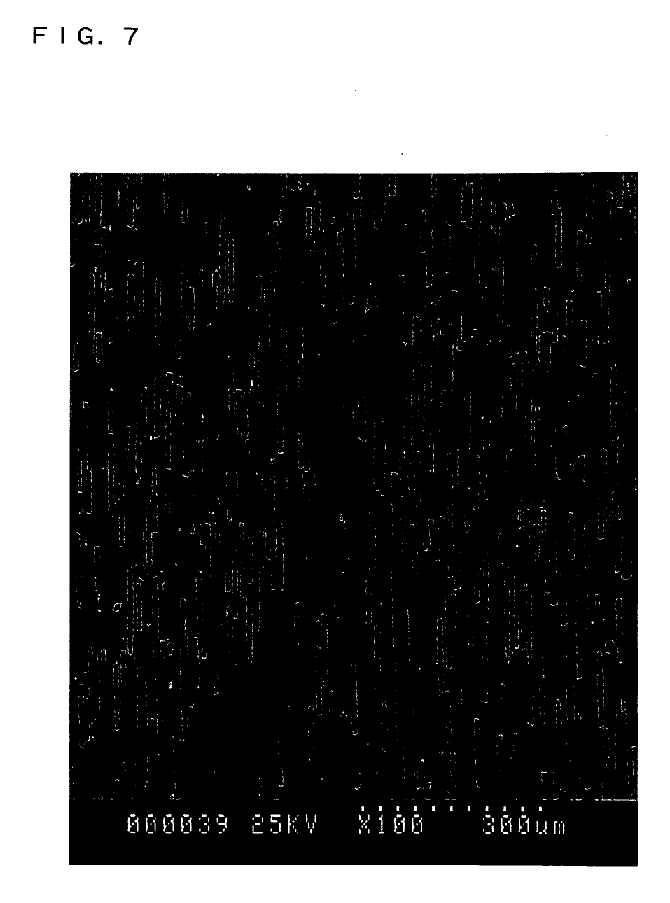

The test pieces of the compound example containing 25% by volume of carbon fiber to which the magnetic field was not applied and the compound example containing 25% by volume of carbon fiber to which the magnetic field was applied were cut in the thickness direction, and the thickness direction orientation of the carbon fiber was observed using a scanning electron microscope. The resulting microphotographs are shown in FIGS. 6 and 7. The dark gray-colored portions denote the polyethylene resin, and the light gray-colored portions denote the carbon fibers. FIG. 6 shows the example to which the magnetic field was not applied, and in this example, the carbon fiber directions are random. FIG. 7 shows the example to which the magnetic field was applied, and in this example, the carbon fiber is oriented regularly in the thickness direction. In other words, the orientation may be considered favorable. Note that the degree of orientation determined from the above Formula 2 relating to the example in which a magnetic field was applied to the compound containing 25% by volume of carbon fiber was 0.98.

[Examples in which Carbon Fiber is Oriented]

### (A) Base Using Polyethylene Resin

Having confirmed that the carbon fiber can be oriented favorably in the preliminary test, examples 1a, 2a, 3a, 5a, 6a, 12a, 13a, 14a, and 15a and comparative examples 1a, 2a, 3a, 4a, and 5a were implemented using the same material compositions and molding methods as examples 1, 2, 3, 5, 6, 12, 13, 14, and 15, and comparative examples 1, 2, 3, 4, and 5, respectively, but differing therefrom in that the carbon fiber in the base polymeric material (polyethylene resin) was oriented using a magnetic field. Note that in these examples, the carbon fiber contained therein was particularly well oriented (the degree of orientation determined from the above Formula 2 was from 0.9 to 1).

Orientation using a magnetic field was performed in a similar manner to the preliminary test described above, using the devices and procedures illustrated in FIGS. 3 and 4. The physical property tests described above were then applied to the test pieces extracted from the space 22 in the device 21. The results are shown in Table 5. In example 1a, the thermal conductivity in an orthogonal direction to the orientation direction of the carbon fiber was also measured, and the resulting value was 1.1 W/m·K.

Further, the melt flow rate (MFR) of each sample was measured in compliance with JISK7210-1999 using the “Melt Indexer model P-001”, manufactured by Toyo Seiki Co., Ltd., at a test temperature of 220° C. and a test load of 2.16 kgf (21.18N). The results are shown in Table 6 below.

TABLE 5

| | | Comparative | Comparative | Comparative | Comparative | Comparative | | |
|---|---|---|---|---|---|---|---|---|
| Composition/Evaluation item | | Example 1a | Example 2a | Example 3a | Example 4a | Example 5a | Example 1a | Example 2a |
| Composition | Polyethylene | 100 | 75 | 60 | 75 | 60 | 80 | 75 |
| (% by volume) | resin | | | | | | | |
| | Carbon fiber | | 25 | 40 | | | 15 | 20 |
| | Boron nitride | | | | 25 | 40 | 5 | 5 |
| | Alumina | | | | | | | |
| | Aluminum | | | | | | | |
| | nitride | | | | | | | |
| Total amounts of | | 0 | 25 | 40 | 25 | 40 | 20 | 25 |
| carbon fiber and ceramics | | | | | | | | |
| Thermal conductivity (W/m · K) | | — | 13 | — | — | — | 7.9 | 11 |
| Volume specific resistance | | — | 2.7 × 10⁻² | 2.3 × 10⁻¹ | — | — | 5 × 10¹³ | 8 × 10¹¹ |
| (Ω · cm) | | | | | | | | |
| Composition/Evaluation item | | Example 3a | Example 5a | Example 6a | Example 12a | Example 13a | Example 14a | Example 15a |
| Composition | Polyethylene | 70 | 70 | 65 | 65 | 60 | 65 | 80 |
| (% by volume) | resin | | | | | | | |
| | Carbon fiber | 20 | 25 | 25 | 25 | 25 | 30 | 15 |
| | Boron nitride | 10 | 5 | 10 | | | | |
| | Alumina | | | | 10 | 15 | 5 | |
| | Aluminum | | | | | | | 5 |
| | nitride | | | | | | | |

| | | | | | | | |
|---|---|---|---|---|---|---|---|
| Total amounts of | 30 | 30 | 35 | 35 | 40 | 35 | 20 |
| carbon fiber and ceramics | | | | | | | |
| Thermal conductivity (W/m · K) | 3.3 | 14.5 | 14.7 | 14.1 | 10 | 14.2 | 6 |
| Volume specific resistance | 5 × 10⁶ | 2 × 10⁸ | 3 × 10⁴ | 3 × 10⁶ | 1 × 10⁴ | 5 × 10⁴ | 3 × 10¹⁰ |
| (Ω · cm) | | | | | | | |

TABLE 6

| | Comparative | Comparative | Comparative | Comparative |
|---|---|---|---|---|
| Sample name | Example 1a | Example 2a | Example 3a | Example 4a |
| $\begin{matrix}MFR \\ [ \begin{matrix}\begin{matrix}g \text{/} 10 min \\ 2.16 kg\end{matrix} \\ 220 ° C .\end{matrix} ]\end{matrix}$ | 115.0 | 34.0 | 16.0 | 20 |
| | Comparative | | | |
| Sample name | Example 5a | Example 1a | Example 2a | Example 3a |
| $\begin{matrix}MFR \\ [ \begin{matrix}\begin{matrix}g \text{/} 10 min \\ 2.16 kg\end{matrix} \\ 220 ° C .\end{matrix} ]\end{matrix}$ | 6.5 | 64.4 | 47.4 | 39.9 |

| Sample name | Example 5a | Example 6a | Example 12a |
|---|---|---|---|
| $\begin{matrix}MFR \\ [ \begin{matrix}\begin{matrix}g \text{/} 10 min \\ 2.16 kg\end{matrix} \\ 220 ° C .\end{matrix} ]\end{matrix}$ | 39.7 | 26.5 | 26.3 |
| Sample name | Example 13a | Example 14a | Example 15a |
| $\begin{matrix}MFR \\ [ \begin{matrix}\begin{matrix}g \text{/} 10 min \\ 2.16 kg\end{matrix} \\ 220 ° C .\end{matrix} ]\end{matrix}$ | 19.8 | 20.6 | 65.8 |

(B) Base Using Resin or the Like Other than Polyethylene Resin

Similarly to the polyethylene resin samples described above, examples 16a though 43a and comparative examples 6a though 8a were also implemented using the same material compositions and molding methods as examples 16 though 43 and comparative examples 6 though 8, in which the base polymeric material is not polyethylene resin, respectively, but differing therefrom in that the carbon fiber in the base polymeric material was oriented using a magnetic field. To orient the carbon fiber, the polypropylene resin samples and PPS resin samples were heated to 220° C. and 320° C., respectively such that orientation of the carbon fiber was performed in a molten state. While the silicone rubber and bisphenol A-type epoxy resin samples were not heated into a molten state such that orientation of the carbon fiber was performed in a state prior to polymerization or the like. The results are shown in Table 7. Note that orientation method and physical property tests performed were the same as those of the samples having polyethylene resin as the base polymeric material.

Further, measurement of the melt flow rate (MFR) of the samples of examples 16a through 24a and comparative example 6a (using polypropylene resin as the base polymeric material) was performed under the same conditions as the samples having polyethylene resin as the base polymeric material, while the melt flow rate (MFR) of the samples of examples 25a through 33a and comparative example 7a (using PPS resin as the base polymeric material) was measured at a test temperature of 320° C. and a test load of 5 kgf (49.03N) (the other conditions being identical to those of examples using polypropylene resin as the base polymeric material). Further, the viscosity of the samples of examples 34a through 42a and comparative example 8a (using silicone rubber as the base polymeric material) and example 43a (using bisphenol A-type epoxy resin as a base polymeric material) in a state prior to polymerization or the like was measured using an E-type viscosity meter (manufactured by Metoc) The results are shown in Table 7.

TABLE 7

| | | Comparative | | | | |
|---|---|---|---|---|---|---|
| Composition/Evaluation item | | Example 6a | Example 16a | Example 17a | Example 18a | Example 19a |
| Composition | Polypropylene | 100 | 80 | 75 | 55 | 55 |
| (% by volume) | resin | | | | | |
| | Carbon fiber | | 15 | 20 | 30 | 35 |
| | Boron nitride | | 5 | 5 | 15 | 10 |
| | Alumina | | | | | |
| | Aluminum nitride | | | | | |
| Compound amount of | | 0 | 20 | 25 | 45 | 45 |
| Carbon fiber and Celamics | | | | | | |
| Thermal conductivity (W/m · K) | | 0.3 | 3.1 | 4.7 | 2.0 | 1.6 |
| Volume specific resistance (Ω · cm) | | 1.0 × 10¹³ | 9 × 10⁸ | 2 × 10¹⁰ | 4 × 10³ | 6 × 10³ |
| | | or more | | | | |
| MFR (g/10 min, 2.16 kg, 220° C.) | | 152 | 85.9 | 64.6 | 4.2 | 6.2 |
| Composition/Evaluation item | | Example 20a | Example 21a | Example 22a | Example 23a | Example 24a |
| Composition | Polypropylene | 80 | 75 | 55 | 55 | 75 |
| (% by volume) | resin | | | | | |
| | Carbon fiber | 15 | 20 | 30 | 35 | 20 |
| | Boron nitride | | | | | |
| | Alumina | 5 | 5 | 15 | 10 | |
| | Aluminum nitride | | | | | 5 |
| Compound amount of | | 20 | 25 | 45 | 45 | 25 |
| Carbon fiber and Celamics | | | | | | |
| Thermal conductivity (W/m · K) | | 3.6 | 5.5 | 2.1 | 1.9 | 5.9 |
| Volume specific resistance (Ω · cm) | | 1 × 10⁹ | 2 × 10⁹ | 2 × 10³ | 5 × 10² | 3 × 10⁸ |
| MFR (g/10 min, 2.16 kg, 220° C.) | | 75.5 | 62.5 | 18.0 | 15.2 | 47.1 |
| | | Comparative | | | | |
| Composition/Evaluation item | | Example 7a | Example 25a | Example 26a | Example 27a | Example 28a |
| Composition | PPS resin | 100 | 80 | 75 | 55 | 55 |
| (% by volume) | Carbon fiber | | 15 | 20 | 30 | 35 |
| | Boron nitride | | 5 | 5 | 15 | 10 |
| | Alumina | | | | | |
| | Aluminum nitride | | | | | |
| Compound amount of | | 0 | 20 | 25 | 45 | 45 |
| Carbon fiber and Celamics | | | | | | |
| Thermal conductivity (W/m · K) | | 0.4 | 2.2 | 2.9 | 1.5 | 1.2 |
| Volume specific resistance | | 1.0 × 10¹³ | 3 × 10⁹ | 3 × 10⁸ | 4 × 10⁴ | 3 × 10² |
| (Ω · cm) | | or more | | | | |
| MFR(g/10 min, 5 kg, 320° C.) | | 91.6 | 54.6 | 40.2 | 3.9 | 5.3 |
| Composition/Evaluation item | | Example 29a | Example 30a | Example 31a | Example 32a | Example 33a |
| Composition | PPS resin | 80 | 75 | 55 | 55 | 75 |
| (% by volume) | Carbon fiber | 15 | 20 | 30 | 35 | 20 |
| | Boron nitride | | | | | |
| | Alumina | 5 | 5 | 15 | 10 | |
| | Aluminum nitride | | | | | 5 |
| Compound amount of | | 20 | 25 | 45 | 45 | 25 |
| Carbon fiber and Celamics | | | | | | |
| Thermal conductivity (W/m · K) | | 2.8 | 3.2 | 1.6 | 1.5 | 2.9 |
| Volume specific resistance | | 1 × 10⁹ | 7 × 10⁷ | 3 × 10⁴ | 8 × 10² | 6 × 10⁸ |
| (Ω · cm) | | | | | | |
| MFR(g/10 min, 5 kg, 320° C.) | | 45.2 | 33.0 | 9.2 | 7.8 | 28.3 |
| | | Comparative | | | | |
| Composition/Evaluation item | | Example 8a | Example 34a | Example 35a | Example 36a | Example 37a |
| Composition | Silicone rubber | 100 | 80 | 75 | 55 | 55 |
| (% by volume) | Bis phenol-A | | | | | |
| | epoxy resin | | | | | |
| | Carbon fiber | | 15 | 20 | 30 | 35 |
| | Boron nitride | | 5 | 5 | 15 | 10 |
| | Alumina | | | | | |
| | Aluminum nitride | | | | | |

| | | | | | |
|---|---|---|---|---|---|
| Compound amount of | 0 | 20 | 25 | 45 | 45 |
| Carbon fiber and Celamics | | | | | |
| Thermal conductivity (W/m · K) | 0.3 | 2.5 | 3.1 | 1.9 | 1.6 |
| Volume specific resistance (Ω · cm) | 1.0 × 10¹³ | 4 × 10¹¹ | 4 × 10⁹ | 4 × 10⁴ | 1 × 10³ |
| | or more | | | | |
| Viscosity (Pa · S) | 3.5 | 7.2 | 43 | 92.3 | 89.2 |

| Composition/Evaluation item | | Example 38a | Example 39a | Example 40a | Example 41a | Example 42a | Example 43a |
|---|---|---|---|---|---|---|---|
| Composition | Silicone rubber | 80 | 75 | 55 | 55 | 75 | |
| (% by volume) | Bis phenol-A | | | | | | 80 |
| | epoxy resin | | | | | | |
| | Carbon fiber | 15 | 20 | 30 | 35 | 20 | 15 |
| | Boron nitride | | | | | | |
| | Alumina | 5 | 5 | 15 | 10 | | 5 |
| | Aluminum nitride | | | | | 5 | |

| | | | | | | |
|---|---|---|---|---|---|---|
| Compound amount of | 20 | 25 | 45 | 45 | 25 | 20 |
| Carbon fiber and Celamics | | | | | | |
| Thermal conductivity (W/m · K) | 2.9 | 3.2 | 1.8 | 1.7 | 3.5 | 3.2 |
| Volume specific resistance (Ω · cm) | 3 × 10⁹ | 2 × 10⁸ | 2 × 10³ | 6 × 10² | 9 × 10⁸ | 1 × 10¹⁰ |
| Viscosity (Pa · S) | 6.4 | 34.3 | 89.9 | 78.3 | 39.1 | 28.3 |

### [Evaluation of Physical Properties]

By orienting the carbon fiber, the following effects were obtained.

### (A) Samples Employing a Polyethylene Resin as the Base Polymeric Material

(1) All of the examples secure both low electric conductivity (volume specific resistance is equal to or more than 1×10² Ω·cm) and high heat radiation (thermal conductivity is equal to or more than 0.5 W/m·K).

(2) In examples, a large improvement was achieved in relation to high heat radiation (thermal conductivity). The low electric conductivity in some cases deteriorated slightly, but the required performance was secured.

(3) In comparative example 2a, on the other hand, a large improvement was achieved in relation to high heat radiation, but the low electric conductivity deteriorated further. In comparative example 3a, the low electric conductivity deteriorated further.

(B) Samples Employing a Resin or the Like Other than Polyethylene Resin as the Base Polymeric Material

(1) All of the examples secure both low electric conductivity (volume specific resistance is equal to or more than 1×10² Ω·cm) and high heat radiation (thermal conductivity is equal to or more than 0.5 W/m·K).

(2) In examples having a carbon fiber compound amount from 15 to 30% by volume, the high heat radiation improved. Particularly, in the examples having a carbon fiber compound amount from 15 to 20% by volume, a large improvement was achieved in relation to high heat radiation.

(3) In examples having a carbon fiber compound amount from 15 to 20% by volume (except the thirty-eighth and thirty-ninth examples), the low electric conductivity improved.

The present invention is not limited to the examples described above, and may be modified appropriately for implementation within a scope that does not depart from the spirit of the invention.

What is claimed is:

1. A low electric conductivity, high heat radiation polymeric composition comprising:
a polymeric material;
from 10 to 35% by volume of a carbon fiber; and
from 1 to 20% by volume of a ceramics.

2. The low electric conductivity, high heat radiation polymeric composition according to claim 1, wherein the polymeric material is a polymeric material having a thermal conductivity of less than 1.0 W/m·K.

3. The low electric conductivity, high heat radiation polymeric composition according to claim 1, wherein the polymeric material is one of polyethylene, polypropylene, polyphenylene sulfide, silicone rubber, and epoxy resin.

4. The low electric conductivity, high heat radiation polymeric composition according to claim 1, wherein the ceramics is one of boron nitride, alumina, and aluminum nitride.

5. The low electric conductivity, high heat radiation polymeric composition according to claim 3, wherein the ceramics is one of boron nitride, alumina, and aluminum nitride.

6. The low electric conductivity, high heat radiation polymeric composition according to claim 4, wherein the carbon fiber is pitch-based carbon fiber.

7. The low electric conductivity, high heat radiation polymeric composition according to claim 5, wherein the carbon fiber is pitch-based carbon fiber.

8. A low electric conductivity, high heat radiation molded body using the low electric conductivity, high heat radiation polymeric composition according to claim 1.

9. The low electric conductivity, high heat radiation molded body according to claim 8, wherein the polymeric material is one of polyethylene, polypropylene, polyphenylene sulfide, silicone rubber, and epoxy resin.

10. The low electric conductivity, high heat radiation molded body according to claim 8, wherein the ceramics is one of boron nitride, alumina, and aluminum nitride.

11. The low electric conductivity, high heat radiation molded body according to claim 9, wherein the ceramics is one of boron nitride, alumina, and aluminum nitride.

12. The low electric conductivity, high heat radiation molded body according to claim 10, wherein the carbon fiber is pitch-based carbon fiber.

13. The low electric conductivity, high heat radiation molded body according to claim 8, wherein the carbon fiber is oriented within the polymeric material.

14. The low electric conductivity, high heat radiation molded body according to claim 9, wherein the carbon fiber is oriented within the polymeric material.

15. The low electric conductivity, high heat radiation molded body according to claim 10, wherein the carbon fiber is oriented within the polymeric material.

16. A method of manufacturing a low electric conductivity, high heat radiation molded body, comprising:
molding at least one of a molded body and a molded body serving as a material of the molded body by using the low electric conductivity, high heat radiation polymeric composition according to claim 1; and
orienting the carbon fiber in the polymeric material of the molded body by using a magnetic field when the polymeric material is in a fluid state.

17. The method according to claim 16, wherein the polymeric material is one of polyethylene, polypropylene, polyphenylene sulfide, silicone rubber, and epoxy resin.

18. The method according to claim 16, wherein the ceramics is one of boron nitride, alumina, and aluminum nitride.

19. The method according to claim 17, wherein the ceramics is one of boron nitride, alumina, and aluminum nitride.

20. The method according to claim 18, wherein the carbon fiber is pitch-based carbon fiber.
